(19) United States
(12) Patent Application Publication
(10) Pub. No.: US 2014/0103049 A1
(43) Pub. Date: Apr. 17, 2014

(54) SHEET FOR USE IN FOOD PREPARATION AND METHOD OF USE THEREOF

(71) Applicant: DAWN FOOD PRODUCTS, INC., Jackson, MI (US)

(72) Inventors: Ronald T. Patterson, Bentonville, AR (US); Richard S. Buck, Lombard, IL (US)

(73) Assignee: DAWN FOOD PRODUCTS, INC., Jackson, MI (US)

(21) Appl. No.: 13/653,134

(22) Filed: Oct. 16, 2012

(51) Int. Cl. A47J 37/01; B65B 3/02; B31F 1/00

(52) U.S. Cl. 220/573.1; 493/405; 53/452

(57) ABSTRACT

A sheet for use in food preparation has a panel that includes a plurality of carrier zones. Each carrier zone is sized to receive a frozen food item. The panel has a folded configuration in which the panel is folded along a plurality of fold lines and has a first surface area, and an unfolded configuration in which the panel has a second surface area larger than the first surface area. Each carrier zone has a first edge defined by a first fold line of the plurality of fold lines and a second edge defined by a second fold line of the plurality of fold lines. The second fold line extends orthogonal to the first fold line. A method of using the sheet is also disclosed.

### TECHNICAL FIELD

The present disclosure relates generally to food preparation and delivery, and, more particularly, to a sheet for use in preparing food items for human consumption.

### BACKGROUND

The commercial frozen food industry, including, for example, large commercial bakeries and small retail bakeries, is a multi-billion dollar business that is responsible for the daily mass production of frozen food items. In addition to making the frozen food items, the commercial bakeries package and ship the frozen food items to local retailers for purchase, preparation, and consumption by consumers. While machines may be used during the production and delivery process, human labor may be required to package the frozen food items for shipment and to arrange the frozen food items for preparation.

### SUMMARY

According to one aspect of the disclosure, a sheet for use in food preparation is disclosed. The sheet has a panel including a plurality of carrier zones, and each carrier zone is sized to receive a frozen food item. The panel has a folded configuration in which the panel is folded along a plurality of fold lines and has a first surface area. The panel also has an unfolded configuration in which the panel has a second surface area larger than the first surface area. Each carrier zone has a first edge defined by a first fold line of the plurality of fold lines and a second edge defined by a second fold line of the plurality of fold lines. The second fold line extends orthogonal to the first fold line.

In some embodiments, when the panel is in the folded configuration, the first edge of a first carrier zone may overlap with a second edge of an adjacent carrier zone. When the panel is in the unfolded configuration, the first edge may be spaced apart from the second edge.

In some embodiments, when the panel is in the folded configuration, the panel may have a first length and a first width. When the panel is in the unfolded configuration, the panel may have a second length that is greater than the first length and a second width that is greater than the first width.

In some embodiments, the panel may include a first pane including a first carrier zone, a second pane including a second carrier zone, and a first bridge extending between the first pane and the second pane. The first bridge may be positioned below the first pane and above the second pane when the panel is in the folded configuration. The first bridge may cooperate with the first pane and the second pane to define a plane when the panel is in the unfolded configuration.

In some embodiments, the panel may further include a third pane including a third carrier zone and a second bridge extending between the first pane and the third pane. The second bridge may be positioned below the first pane and above the third pane when the panel is in the folded configuration. The second bridge may cooperate with the first pane, the second pane, the third pane, and the first bridge to define a plane when the panel is in the unfolded configuration.

In some embodiments, the sheet may include a first bridge and a second bridge that partially overlaps with the first bridge when the panel is in the folded configuration. Additionally, in some embodiments, the sheet may include a panel that is formed from parchment paper.

In some embodiments, the locking mechanism may include an outer flange positioned along an outer perimeter of the panel. The outer flange may include a plurality of locking flanges positioned below a bottom surface of the panel. Additionally, in some embodiments, the outer flange may further include a plurality of tabs extending outwardly from below the panel.

According to another aspect of the disclosure, a method of food preparation is disclosed. The method includes obtaining a folded sheet having a plurality of frozen food items positioned thereon, with each frozen food item being adjacent to at least one other frozen food item. The method also includes expanding the folded sheet along a first axis to increase a first dimension of the folded sheet and expanding the folded sheet along a second axis to increase a second dimension of the folded sheet. The second axis is orthogonal to the first axis. When the folded sheet is expanded along the first axis and the second axis, an unfolded sheet is produced on which the frozen food items are spaced apart.

In some embodiments, the method may further include positioning the folded sheet on a baking pan. The baking pan may have a pan surface area. The folded sheet may have a surface area that is less than the pan surface area. The unfolded sheet may have a surface area that is approximately equal to the pan surface area. In some embodiments, the method may further include placing the unfolded sheet into an oven, and baking the frozen food items in the oven. In some embodiments, obtaining a folded sheet may include removing a package including the folded sheet and the plurality of frozen food items from a container.

In some embodiments, the package may include a cover sheet, and the folded sheet may be positioned below the cover sheet. The plurality of frozen food items may be positioned between the cover sheet and the folded sheet. In some embodiments, the method may further include removing the cover sheet from the plurality of frozen food items before expanding the folded sheet.

According to another aspect of the disclosure, a method of delivering frozen food items is disclosed. The method includes depositing a plurality of frozen food items on a first sheet and placing a second sheet over the plurality of frozen food items to create a package. The second sheet is folded along a plurality of first fold lines and a plurality of second fold lines extends orthogonal to the first fold lines. In some embodiments, the method may also include inserting the package into a container and rotating the container 180 degrees such that the second sheet is positioned below the plurality of frozen food items and the first sheet is positioned above the plurality of frozen food items. Additionally, the method includes sealing the container.

In some embodiments, the method may further include removing the package from the container, detaching the first sheet from the plurality of frozen food items, unfolding the second sheet along the first fold lines to increase a first dimension of the second sheet, and unfolding the second sheet along the second fold lines to increase a second dimension of the second sheet. Unfolding the second sheet along the first fold lines and the second fold lines may create an unfolded sheet on which the frozen food items are spaced apart.

In some embodiments, unfolding the second sheet along the first fold lines may include pulling on a first tab in a first direction and a second tab in a second direction opposite the first direction.

Additionally, in some embodiments, the method may further include depositing a plurality of frozen food items on a third sheet, placing the fourth sheet over the plurality of frozen food items to create a second package. The fourth sheet may be folded along a plurality of first fold lines and a plurality of second fold lines extending orthogonal to the first fold lines. The method may also include inserting the second package into the container such that the third sheet is placed in contact with the first sheet.

### BRIEF DESCRIPTION OF THE DRAWINGS

The detailed description particularly refers to the following figures, in which:

FIG. 1 is a perspective view of a package of frozen food items including a folded carrier sheet and a cover sheet;

FIG. 2 is a perspective view of the carrier sheet of FIG. 1 when unfolded and positioned on a pan;

FIG. 3 is a top view of the carrier sheet of FIG. 1 when unfolded;

FIG. 4 is a top view of the carrier sheet of FIG. 1 when folded;

FIG. 5 is bottom view of the carrier sheet of FIG. 1 when folded;

FIG. 6 is a cross-sectional, side elevation view of the carrier sheet taken along the line 6-6 of FIGS. 4 and 5;

FIG. 7 is a cross-sectional, side elevation view of another embodiment of a fold of the carrier sheet;

FIG. 8 is a cross-sectional, side elevation view taken along the line 8-8 of FIGS. 4 and 5;

FIG. 9 is an exploded, perspective view of the package of FIG. 1;

FIG. 10 is a perspective view of a container and a plurality of the packages of FIG. 1;

FIG. 11 is a perspective view of the carrier sheet and frozen food items positioned on a baking pan;

FIG. 12 is a flowchart showing a method of using the package of FIG. 1; and

FIGS. 13 and 14 illustrate steps of the method shown in FIG. 12.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

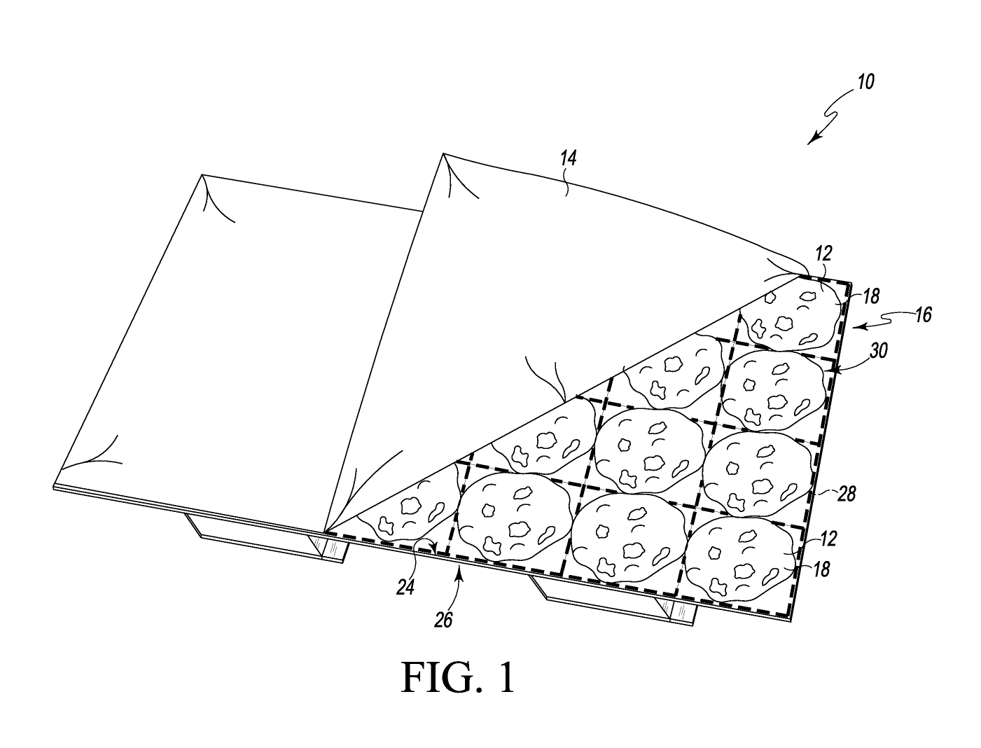

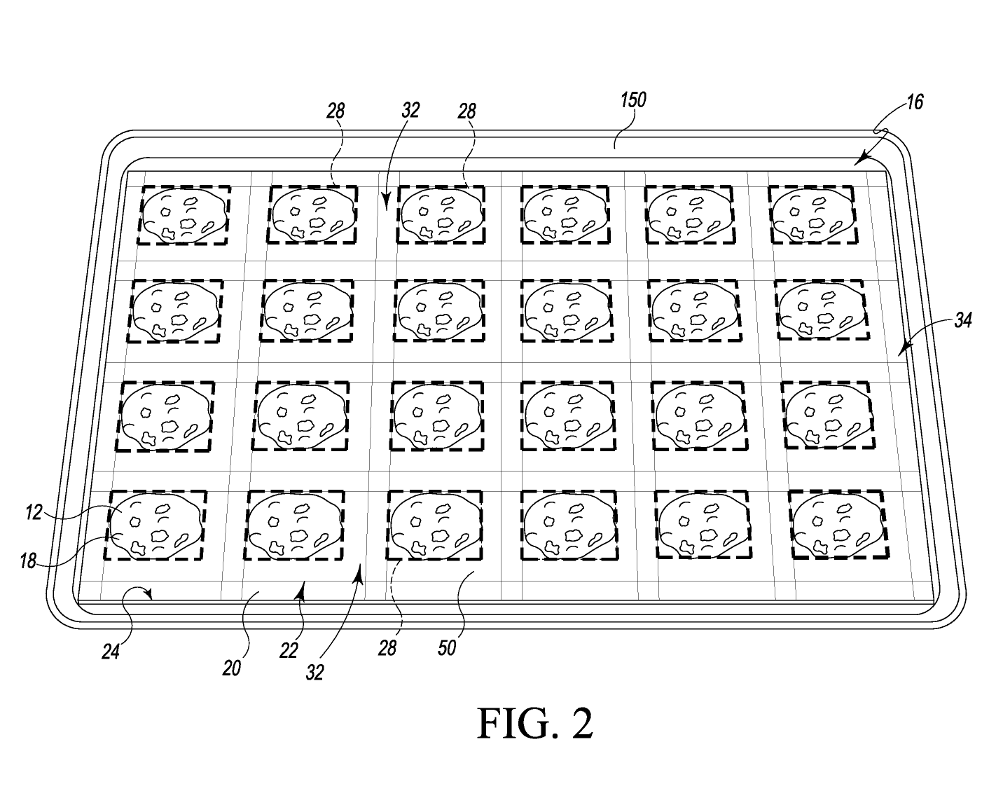

Referring now to FIG. 1, a food package 10 (hereinafter package 10) that may be used to deliver and prepare food items 12 for consumption is shown. The package 10 includes a cover sheet 14 and a carrier sheet 16. The food items 12 are positioned between the cover sheet 14 and the carrier sheet 16. As described in greater detail below, the carrier sheet 16 has a folded configuration (see FIG. 1) in which the food items 12 may be positioned in contact with each other and an unfolded configuration (see FIG. 2) in which the food items 12 are spaced apart from each other prior to cooking or baking.

The cover sheet 14 of the package 10 is made from any paper material suitable for use in cooking and/or baking food items for human consumption. The cover sheet 14 is rectangular and has approximately the same size and dimensions as the folded configuration of the carrier sheet 16. In use, the cover sheet 14 assists in protecting the integrity and quality of the food items 12 during packaging and delivery. In the illustrative embodiment, the cover sheet 14 is removed from the food items 12 prior to baking or cooking. It should be appreciated that in other embodiments the package 10 may not include the cover sheet 14.

As shown in FIGS. 1 and 2, each of the food items 12 is a frozen cookie puck 18. It should be appreciated that in other embodiments the package 10 may be utilized with a variety of food items 12 such as, for example, frozen cakes, brownies, muffins, cupcakes, breads, biscuits, rolls, croissants, and pastries. In addition, the package 10 may be utilized with other frozen food items 12 such as miniature cookies, pies, tarts, pizzas, quiches, and soufflés.

Referring now to FIG. 2, the package 10 is shown without the cover sheet 14 on a baking pan 150. The carrier sheet 16 of the package 10 is made from any paper material suitable for use in cooking and/or baking food items for human consumption. As shown in FIG. 2, the carrier sheet 16 includes a foldable panel 22 and an outer flange 20. As described in greater detail below, the outer flange 20 is operable to maintain the foldable panel 22 in the folded configuration of FIG. 1. The panel 22 has a top surface 24 and a bottom surface 26 positioned opposite the top surface 24. The top surface 24 includes a plurality of carrier zones 28 for the food items 12. In the illustrative embodiment, each carrier zone 28 is sized to receive a single cookie puck 18. However, in other embodiments, the size of the carrier zones 28 may be adjusted to fit the size of other food items 12.

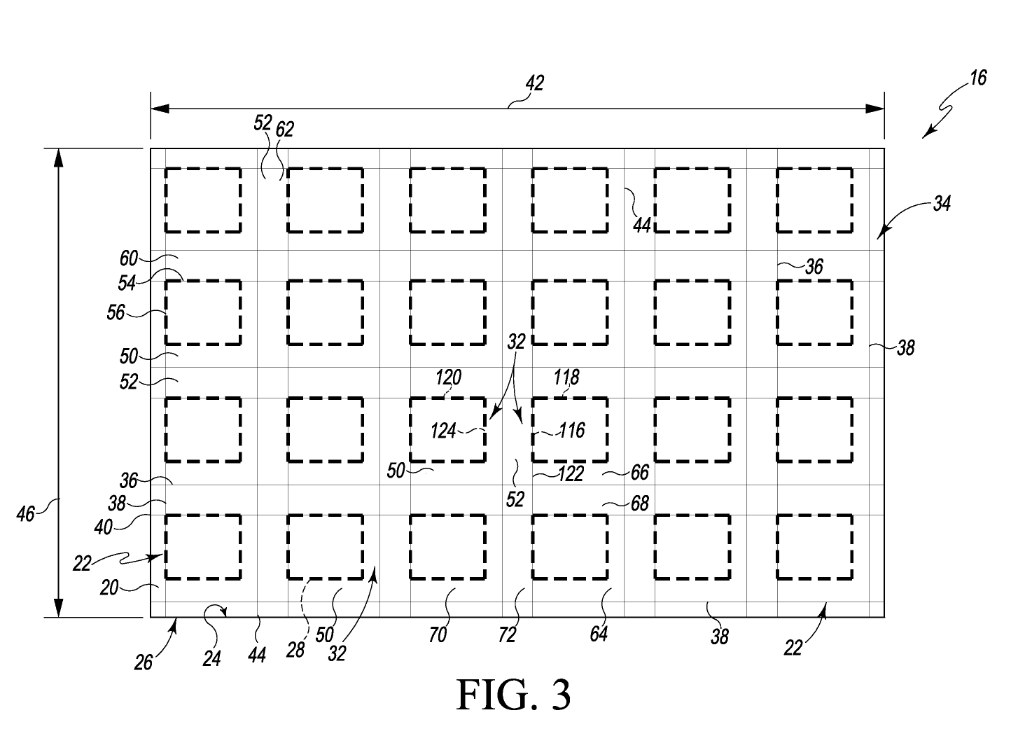

When the carrier sheet 16 is folded as shown in FIG. 1, the carrier zones 28 are packed together such that the cookie pucks 18 are positioned adjacent to each other. In the illustrative embodiment, each cookie puck 18 is in contact with at least one other cookie puck 18. It should be appreciated that in other embodiments the cookie pucks 18 may be slightly spaced apart from each other. In the folded configuration, the top surface 24 of the carrier sheet 16 has a surface area 30 defined by the carrier zones 28. When the carrier sheet 16 is unfolded, as shown in FIGS. 2 and 3, a plurality of expansion spaces 32 are defined between the carrier zones 28, thereby spacing the cookie pucks 18 apart from each other. In the unfolded configuration, the top surface 24 of the carrier sheet 16 has a surface area 34 that is larger than the surface area 30. The surface area 34 of the carrier sheet 16 is defined by the carrier zones 28 and the expansion spaces 32.

The carrier sheet 16 is folded along a plurality of internal fold lines 36 and a plurality of perimeter fold lines 38, which are illustrated in FIG. 3. In the illustrative embodiment, an internal fold line 36 is one that lies within the panel 22, and a perimeter fold line 38 is one that lies along the outermost portion and/or the perimeter of the panel 22 and separates the panel 22 from the outer flange 20. The fold lines 36, 38 include a plurality of longitudinal fold lines 40 that extend along the length 42 of the carrier sheet 16 and a plurality of transverse fold lines 44 that extend along the width 46 of the carrier sheet 16. As described in greater detail below, a user unfolds the sheet 16 along the longitudinal fold lines 40 to expand the width 46 of the carrier sheet 16. A user unfolds the sheet 16 along the transverse fold lines 44 to expand the length 42 of the carrier sheet 16.

The internal fold lines 36 of the sheet 16 cooperate to divide the panel 22 into a plurality of panes 50 and a plurality of bridges 52 extending between the panes 50. In the illustrative embodiment, the panel 22 includes twenty-four panes 50. It should be appreciated that in other embodiments the panel 22 may include a greater or lesser number of panes 50. Additionally, in the illustrative embodiment, each pane 50 is rectangular in shape, but it should be appreciated that in other embodiments the panes 50 may take other geometric forms, such as, for example, a square shape. Each pane 50 has a pair of edges 54 defined by the longitudinal fold lines 40 and a pair of edges 56 defined by the transverse fold lines 44.

As shown in FIG. 3, the bridges 52 of the panel 22 include a number of longitudinal bridges 60 that connect the edges 54 of adjacent panes 50 and a number of transverse bridges 62 that connect the edges 56 of adjacent panes 50. When the panel 22 is in the unfolded configuration, the bridges 60, 62 and the panes 50 define and lie in a common plane. When the panel 22 is folded, the bridges 60, 62 are positioned between the panes 50.

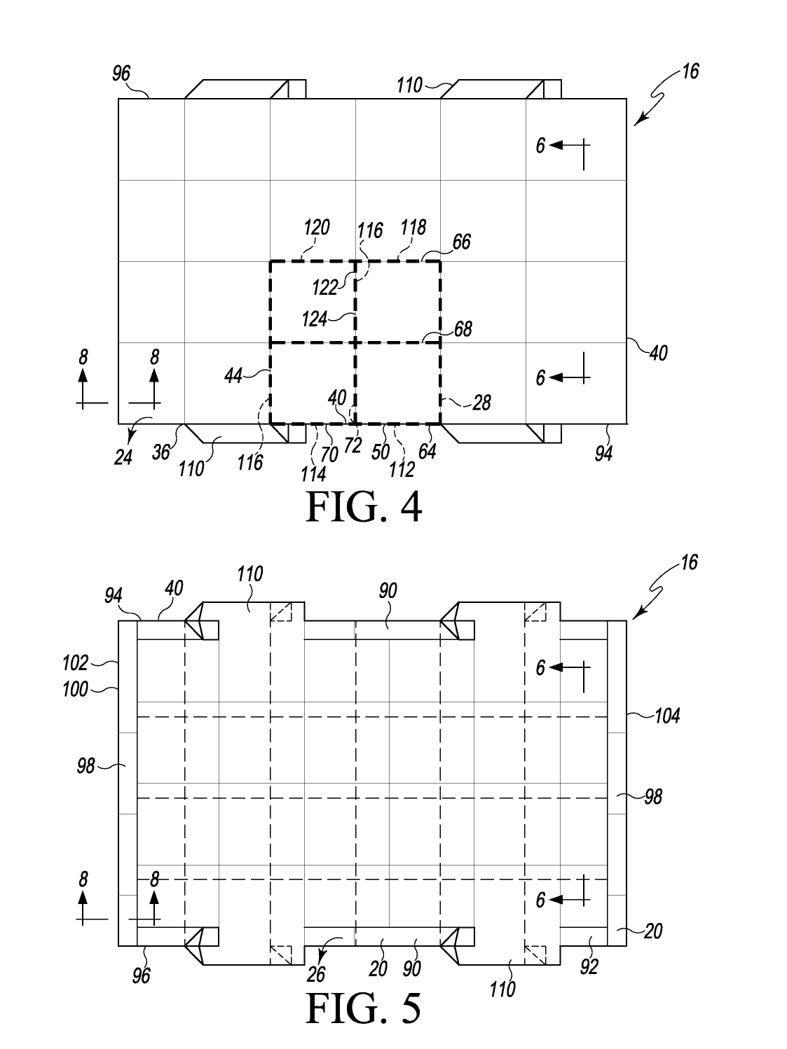

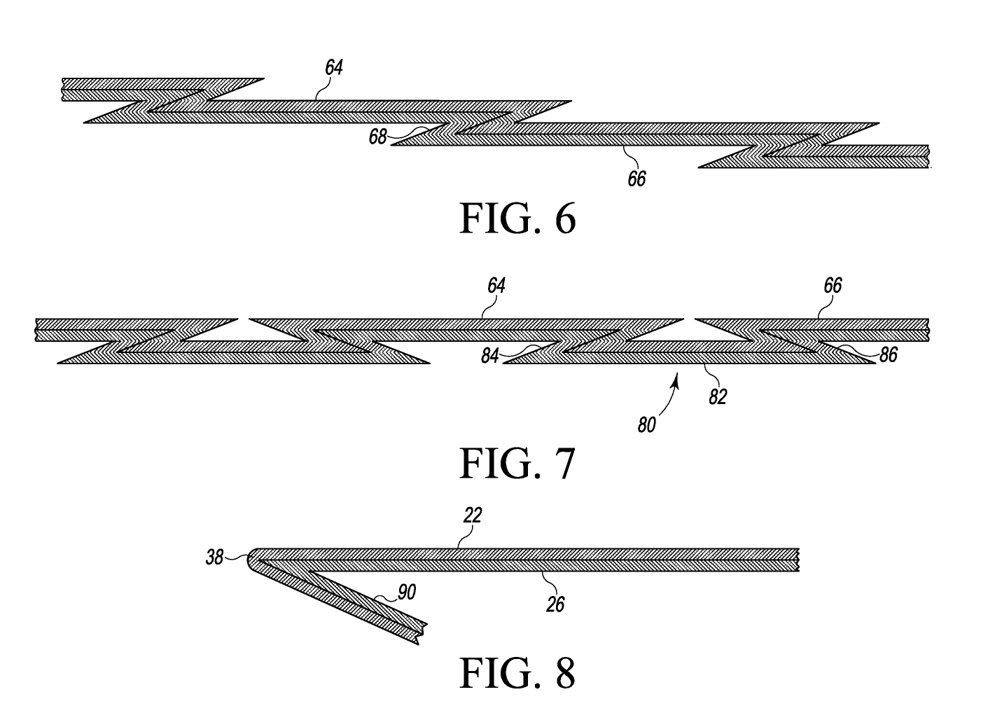

For example, as shown in FIGS. 4 and 5, the sheet 16 includes a pane 64 connected to another pane 66 via a longitudinal bridge 68. Additionally, the pane 64 is connected to another pane 70 via a transverse bridge 72. In the illustrative embodiment, the transverse bridge 72 and the longitudinal bridge 68 partly overlap when the sheet 16 is folded. As shown in FIG. 6, the longitudinal bridge 68 is positioned between the panes 64, 66 when the sheet 16 is in the folded configuration. Such a configuration is an example of a z-fold. When the sheet 16 is expanded to the unfolded configuration, the bridges 68, 72 lie in a common plane with the panes 64, 66, 70, as shown in FIG. 3. In the unfolded configuration, the panes 64, 66, 70 are spaced apart by the bridges 68, 72.

It should be appreciated that in other embodiments the sheet 16 may be folded in different arrangements to change the position of the bridges 52 and the panes 50. For example, as shown in FIG. 7, the panes 64, 66 are connected via a bridge 80. The bridge 80 includes a middle section 82 that is connected to the pane 64 via a folded section 84. The middle section 82 of the bridge 80 is also connected to the pane 66 via a folded section 86. When the sheet is folded, the pane 66 and folded section 86 are compressed between the folded section 84, the pane 64, and the middle section 82. Such a configuration is an example of a key-fold.

As described above, the carrier sheet 16 includes an outer flange 20 that is operable to maintain the foldable panel 22 in the folded configuration. As shown in FIG. 5, the outer flange 20 includes locking flanges 90 that are connected to the panel 22 at longitudinal fold lines 40 on the sides 94, 96 of the sheet 16. The outer flange 20 also includes locking flanges 98 that is connected to the panel 22 at transverse fold lines 100 on the ends 102, 104. When the sheet 16 is folded, the locking flanges 90 are positioned below the bottom surface 26 of the panel 22, as shown in FIG. 8. Additionally, as shown in FIG. 5, the locking flanges 90 are positioned between the bottom surface 26 of the panel 22 and the locking flanges 98. The locking flanges 90, 98 cooperate to lock the z-folds of the panel 22 in place, thereby maintaining the panel 22 in the folded configuration. In that way, the flanges 90, 98 act as a locking mechanism of the carrier sheet 16. It should be appreciated that in other embodiments the sheet 16 may include pins, clips, or other fasteners to maintain the panel 22 in the folded configuration.

When the sheet 16 is folded as shown in FIGS. 4 and 5, the outer flange 20 defines a plurality of tabs 110, which extend outwardly from the sides 94, 96 of the sheet 16. Each tab 110 extends outwardly from the below the bottom surface 26 when the sheet 16 is folded. Referring now to FIG. 5, the tabs 110 are formed by unfolding a section of the locking flange 90. The left portion of the locking flange 90 is folded back to form a triangular shape. The right portion of the locking flange 90 is overlapped by an adjacent locking flange 92 and is further tucked underneath the adjacent locking flange 92 to create the tab 110. As described in greater detail below, a user may grasp the tabs 110 to expand the sheet 16 from the folded configuration to the unfolded configuration. It should be appreciated that in other embodiments the carrier sheet may include one or more tabs extends outwardly from the transverse fold lines.

As shown in FIG. 4, each pane 50 of the panel 22 includes a carrier zone 28 that is sized and shaped to receive a food item 12. Each carrier zone 28 is defined by a plurality of edges 112. The plurality of edges 112 of each carrier zone 28 includes an edge 114 and an edge 116 that are coincident with one of the fold lines 40, 44, respectively. In particular, each carrier zone 28 has one edge 114 defined by a longitudinal fold line 40 and one edge 116 defined by a transverse fold line 44. As such, the edge 114 extends orthogonal to the edge 116.

When the sheet 16 is folded, one of the edges 112 of one carrier zone (e.g., carrier zone 118) overlaps with the one of the edges 112 of an adjacent carrier zone (e.g., carrier zone 120). For example, the edge 116 of the carrier zone 118, which is defined by the longitudinal fold line 122, overlaps with the edge 124 of the carrier zone 120, when the sheet 16 is folded as shown in FIG. 4. When the sheet 16 is unfolded as shown in FIG. 3, the edge 116 of the carrier zone 118 is spaced apart from the edge 124 of the carrier zone 120. As described above, an expansion space 32 is positioned between the edges 116, 124 of the carrier zones 118, 120. In the illustrative embodiment, each expansion space 32 is defined by a bridge 52 and a portion of a pane 50.

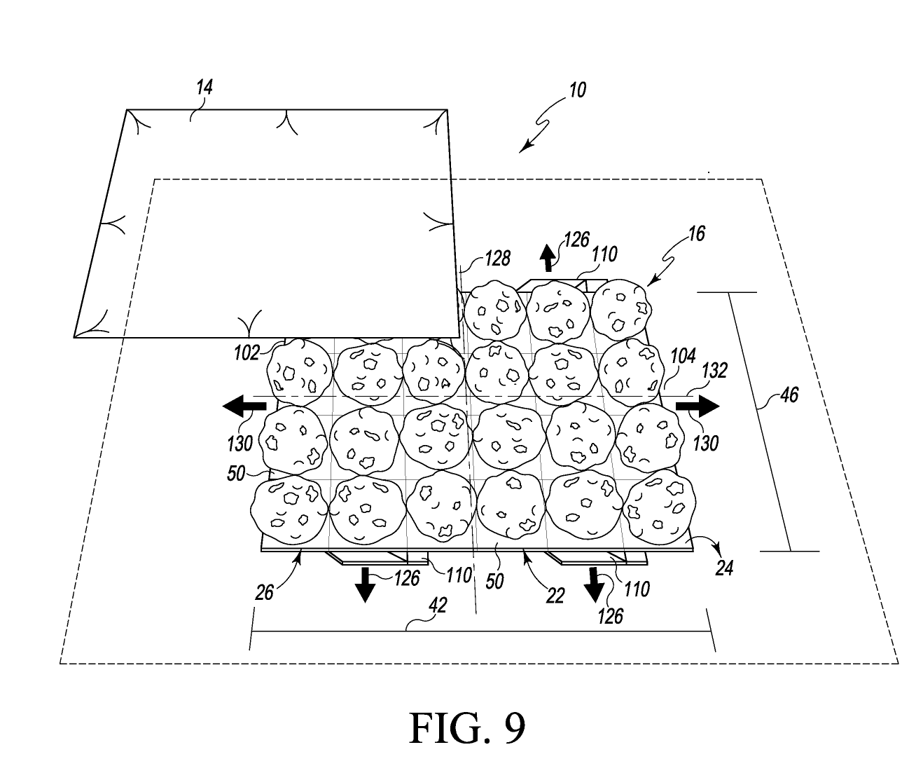

As shown in FIG. 9, the sheet 16 of the package 10 may be expanded from the folded configuration to the unfolded configuration. To do so, the user may grasp the tabs 110 and pull in the direction indicated by arrows 126 to expand the carrier sheet 16 along its transverse axis 128. In other words, the tabs 110 may be utilized to expand the width 46 of the sheet 16. As the user pulls in the direction indicated by arrows 126, the locking flanges 90 are withdrawn from below the bottom surface 26 of the panel 22, thereby unlocking the sheet 16 (see FIG. 5). The longitudinal bridges 60 are unfolded and the panes 50 are moved apart from one another along the transverse axis 128.

As the user pulls on the tabs 110, the locking flanges 98 are also withdrawn from below the bottom surface 26 of the panel 22 (see FIG. 5). The user may then grasp the ends 102, 104 of the sheet 16 and pull in the direction indicated by arrows 130 to expand the sheet 16 along its longitudinal axis 132. As the user pulls in the direction indicated by arrows 130, the transverse bridges 62 are unfolded and a number of the panes 50 are moved apart from one another along the longitudinal axis 132. When the sheet 16 is fully expanded along both axes 128, 132, the sheet 16 is completely unfolded and the panes 50, the bridges 52, and the outer flange 20 lie in a common plane (see FIG. 3).

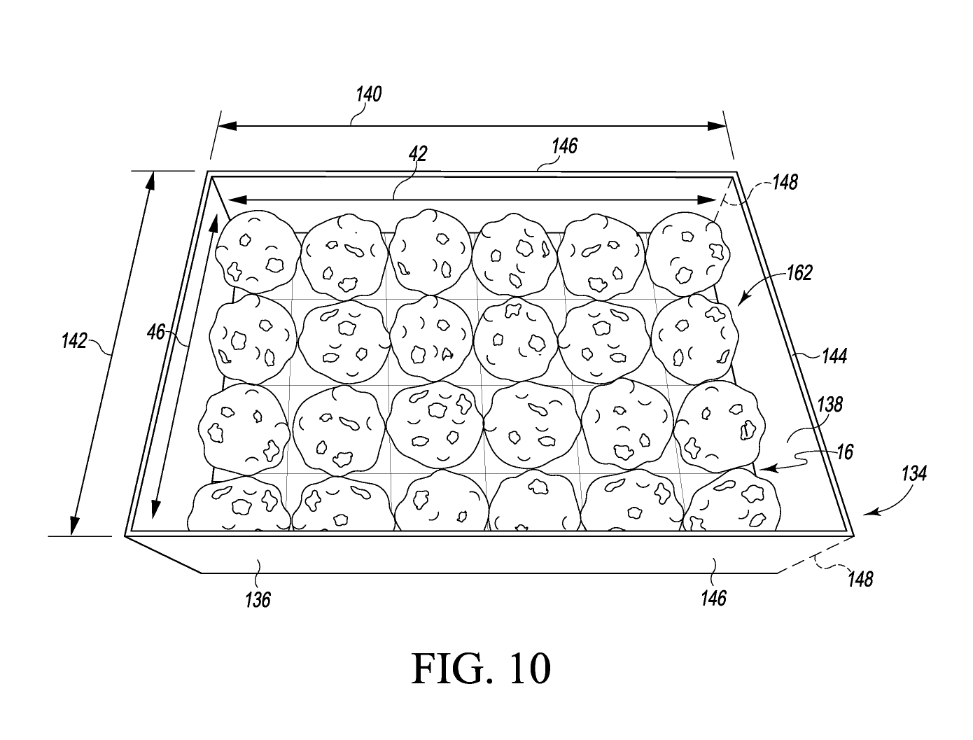

Referring now to FIG. 10, the package 10 is shown without the cover sheet 14 in a shipping container 134. In the illustrative embodiment, the container 134 is a cardboard box sized to receive a plurality of packages 10. It should be appreciated that in other embodiments the container may be a tray, plastic bag, or other parcel sized to receive one or more of the packages 10. The container 134 includes a number of walls 136 that define a storage chamber 138. One or more packages 10 may be positioned in the chamber 138 for shipment, with each package 10 being stacked upon another package 10. As shown in FIG. 10, the chamber 138 has a length 140 and a width 142 approximately equal to the length 42 and the width 46, respectively, of the sheet 16 when the sheet is folded.

In the illustrative embodiment, the container 134 includes a side door 144 connected to a pair of walls 146 via perforated edges 148. The side door 144 may be detached from the walls 146 and opened, thereby permitting access to the chamber 138 and the packages 10 positioned therein. It should be appreciated that in some embodiments of the container 134, the edges 148 connecting the walls 146 to the side door 144 may not be perforated. In such embodiments, the side door 144 may be created and/or opened manually by the user. The user may utilize an opening device such as a knife, scissors, or a boxcutter to create and/or open the side door 144 of the container 134.

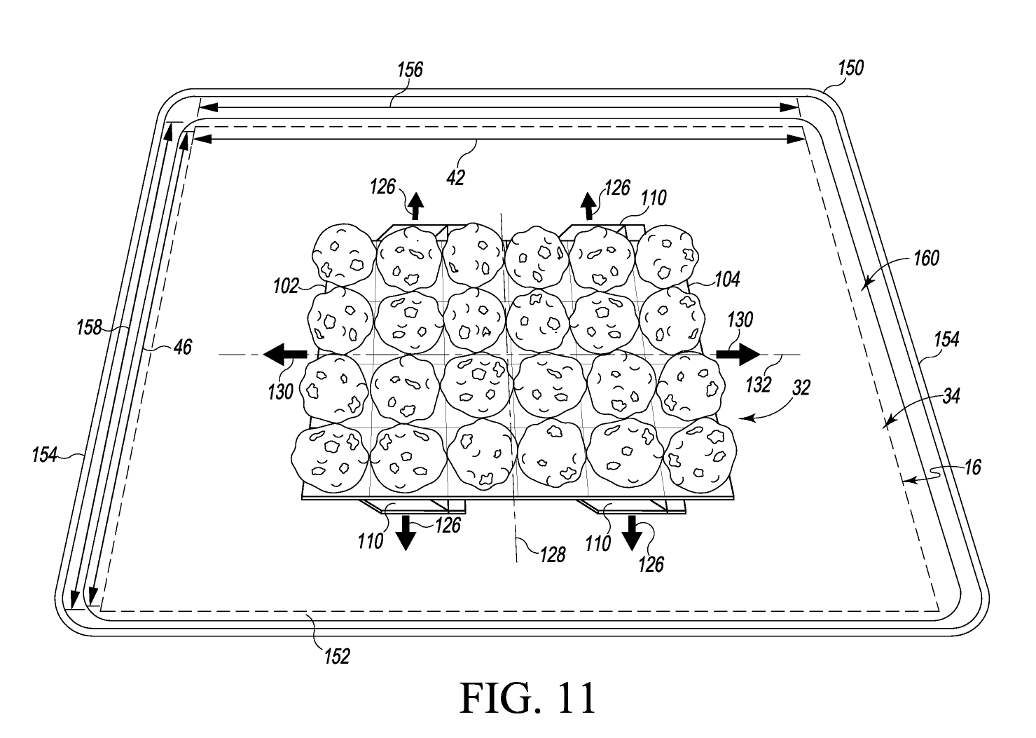

Referring now to FIG. 11, the package 10 is shown with a cooking pan 150. In the illustrative embodiment, the cooking pan 150 is a standard cookie sheet pan. It should be appreciated that in other embodiments the pan 150 may be a pastry, pie, or other cooking pans. The cooking pan 150 has a pan surface 152 and a plurality of side walls 154 extending upwardly from the pan surface 152. The pan surface 152 has a length 156 and a width 158. In the illustrative embodiment, the length 156 of the pan surface 152 has a magnitude of approximately twenty-four inches and the width 158 has a magnitude of approximately sixteen inches. It should be appreciated in other embodiments the length and the width of the pan 150 may be other magnitudes. For example, the length 156 may be approximately eighteen inches and the width 158 may be approximately thirteen inches. The length 156 and the width 158 cooperate to define a surface area 160 of the pan surface 152.

The package 10 may be removed from the container 134 and positioned on the surface 152 of the pan 150, as shown in FIG. 11. The cover sheet 14 positioned over the cookie pucks 18 may be removed before or after the package 10 is placed on the pan 150. When the carrier sheet 16 is in the folded configuration, the carrier sheet 16 has a surface area 34 defined by the carrier zones 28. As shown in FIG. 11, the surface area 34 is less than the surface area 160 of the surface 152.

After the sheet 16 is positioned on the pan 150, a user may unfold the sheet 16. To do so, the user may grasp the tabs 110 and pull in the direction indicated by arrows 126 to expand the carrier sheet 16 along its transverse axis 128. As the user pulls in the direction indicated by arrows 126, the longitudinal bridges 60 are unfolded and a number of the panes 50 are moved apart from one another along the transverse axis 128. In the illustrative embodiment, the width 46 of the sheet 16 is approximately equal to the width 158 of the pan surface 152 when the carrier sheet 16 is fully expanded along its transverse axis 128.

As the user pulls on the tabs 110, the locking flanges 98 are also withdrawn from below the bottom surface 26 of the panel 22. The user may then grasp the ends 102, 104 of the sheet 16 and pull in the direction indicated by arrows 130 to expand the sheet 16 along its longitudinal axis 132. In the illustrative embodiment, the length 42 of the sheet 16 is approximately equal to the length 156 of the pan surface 152 when the carrier sheet 16 is fully expanded along its longitudinal axis 132. Thus, when the carrier sheet 16 is positioned in the unfolded configuration, the surface area 34 of the sheet 16 is approximately equal to the surface area 160 of the pan 150.

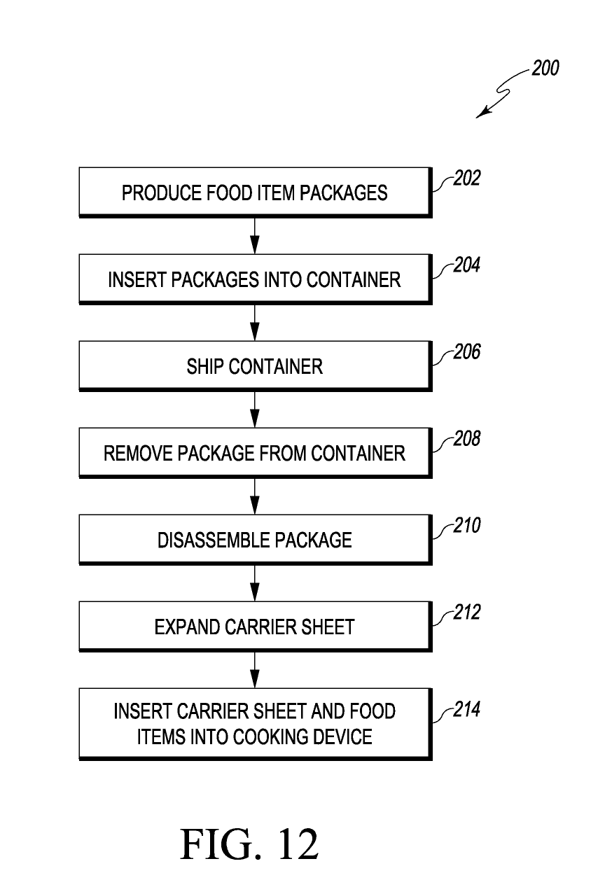

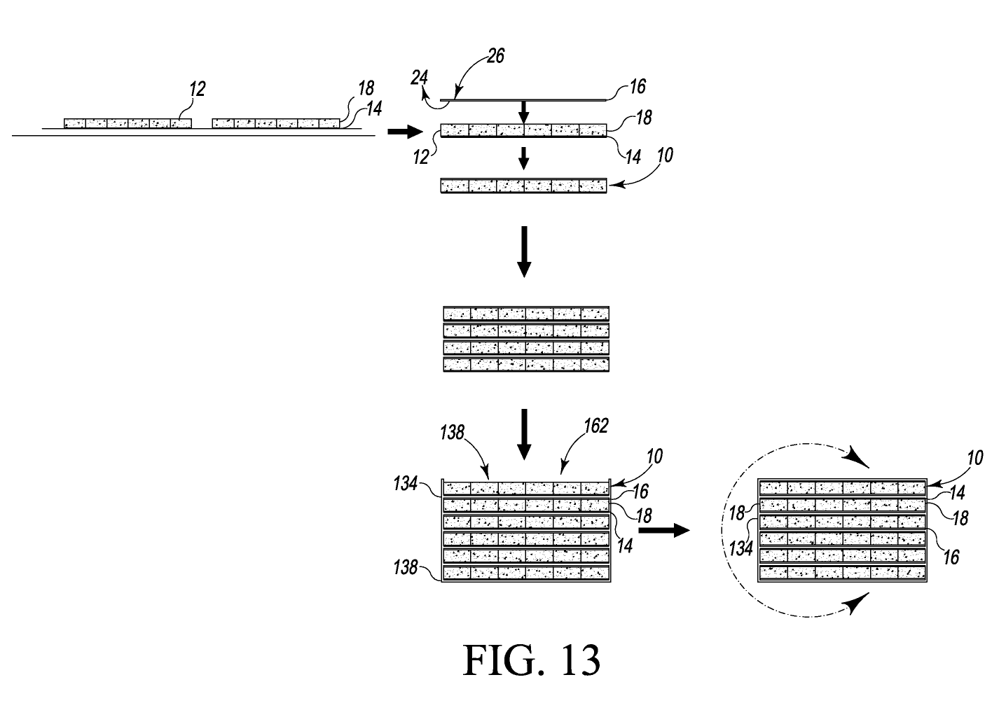

Referring now to FIG. 12, a method 200 of making and using the package 10 is shown. The method 200 includes block 202 in which one or more food item packages 10 are produced. To do so, a plurality of frozen cookie pucks 18 are made and deposited on the cover sheet 14, as shown in FIG. 13. To make the cookie pucks 18, raw materials are combined in a mixer to form the cookie dough which is transferred to a hopper. From the hopper the cookie dough is extruded, cut, and deposited as cookie pucks 18 onto a production material, such as the cover sheet 14. In other embodiments, the cookie pucks 18 may be deposited onto the folded carrier sheet 16. The cookie pucks 18 are then frozen and packed together on the sheet 14 such that the cookie pucks 18 are positioned adjacent with each other.

After the cookie pucks 18 are produced and deposited on the sheet 14, a carrier sheet 16 is positioned above the cookies pucks 18 and aligned with the cover sheet 14. As shown in FIG. 13, the top surface 24 of the sheet 16 faces downward, toward the cookie pucks 18. The carrier sheet 16 may be moved downward into contact with the cookie pucks 18 such that each puck 18 is positioned on a carrier zone 28 located on the top surface 24 of the sheet 16. As described above, the cookie pucks 18 are positioned in contact with each other in the illustrative embodiment. In other embodiments, the cookie pucks 18 may be slightly spaced apart from each other. In such embodiments, a spacer frame or rack may be used to maintain the cookie pucks 18 in position on their respective carrier zones 28. When the sheet 16 is engaged with the cookie pucks 18, one package 10 has been produced. In the illustrative embodiment, additional packages 10 may be produced in a similar manner for shipment in the same container 134.

After one or more packages 10 have been produced, the method 200 may advance to block 204 in which the packages 10 are inserted into the container 134. As shown in FIG. 13, each package 10 is positioned above the container 134 and aligned with an opening 162 defined in the container 134. The package 10 may then be advanced downward through the opening 162 and into the storage chamber 138. Additional packages 10 may be stacked on the package 10, with the cover sheet 14 of one package 10 engaging the bottom surface 26 of the next package 10. The package 10 may be positioned in the container 134 by hand or via a machine.

After one or more packages 10 are positioned in the storage chamber 138 of the container 134, the opening 162 may be sealed. As shown in FIG. 13, the container 134 may then be rotated 180 degrees such that each carrier sheet 16 of each package 10 is positioned below the cookie pucks 18 and the cover sheet 14 of each package 10. The container 134 may be further sealed for shipment.

Returning to FIG. 12, the method 200 continues to block 206 in which the container 134 is shipped from the commercial bakery to a retailer. When the container 134 arrives at the retailer, the method 200 advances to block 208.

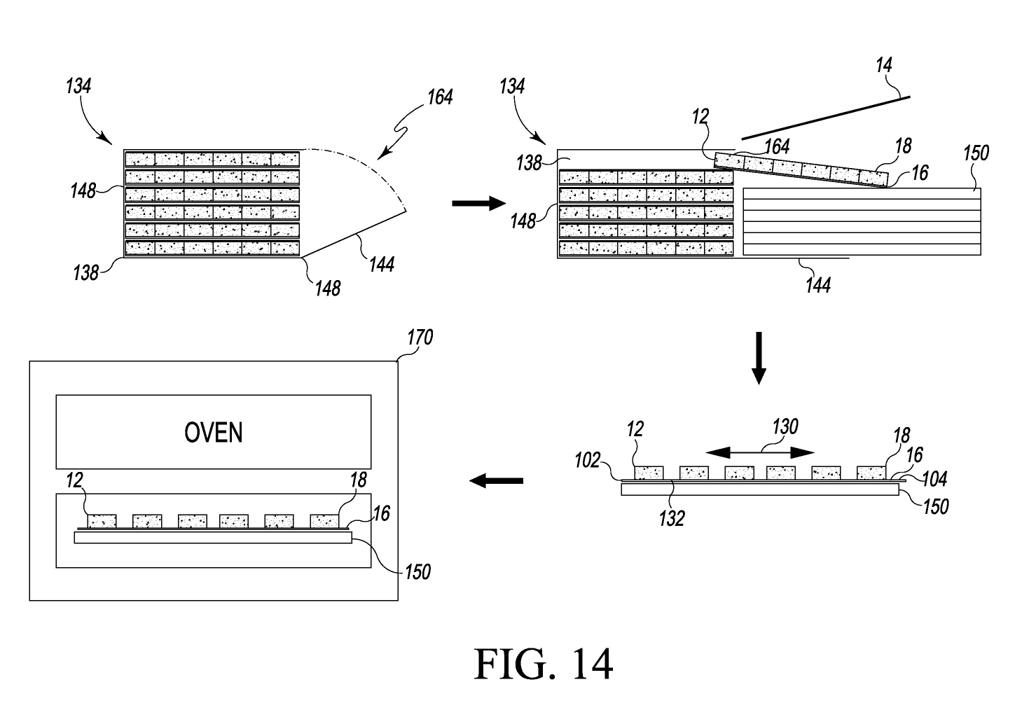

In block 208, the packages 10 in the container 134 are removed from the container 134. To do so, a user may pull or cut away the side door 144 of the container 134, as shown in FIG. 14. Once the user detaches the door 144 from the walls 146 of the container 134 to create an opening 164, the user may then access the packages 10 positioned in the chamber 138 through the opening 164. Each package 10 may be removed and positioned on a cooking pan 150.

The method 200 may advance to block 210 after a package 10 is removed from the container 134. In block 210, the cover sheet 14 is removed from the cookie pucks 18 and discarded. The carrier sheet 16 may then be positioned in the approximate center of the pan 150 before the method 200 advances to block 212.

In block 212, the carrier sheet 16 is expanded from its folded configuration to its unfolded configuration. To do so, the user may grasp the tabs 110 and pull in the direction indicated by arrows 126 to expand the carrier sheet 16 along its transverse axis 128, as shown in FIG. 11. In other words, the tabs 110 may be utilized to expand the width 46 of the sheet 16. As the user pulls in the direction indicated by arrows 126, the locking flanges 90 are withdrawn from below the bottom surface 26 of the panel 22, thereby unlocking the sheet 16. The longitudinal bridges 60 are unfolded and the panes 50 are moved apart from one another along the transverse axis 128. As described above, the width 46 of the sheet 16 is approximately equal to the width 158 of the pan surface 152 when the carrier sheet 16 is fully expanded along its transverse axis 128.

As the user pulls on the tabs 110, the locking flanges 98 are also withdrawn from below the bottom surface 26 of the panel 22. The user may then grasp the ends 102, 104 of the sheet 16 and pull in the direction indicated by arrows 130 to expand the sheet 16 along its longitudinal axis 132. As the user pulls in the direction indicated by arrows 130, the transverse bridges 62 are unfolded and a number of the panes 50 are moved apart from one another along the longitudinal axis 132. The length 42 of the sheet 16 is approximately equal to the length 156 of the pan surface 152 when the carrier sheet 16 is fully expanded along its longitudinal axis 132. When the sheet 16 is fully expanded along both axes 128, 132, the sheet 16 is completely unfolded and the method advances to block 214.

In block 214, after the sheet 16 is completely unfolded on the pan 150, the pan 150 may be positioned in an oven 170 as illustrated in FIG. 14. The cookie pucks 18 may be baked for a predetermined amount of time. When the predetermined time has elapsed, the pan 150 may be removed from the oven 170.

There is a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

1. A sheet for use in food preparation, comprising:
a panel including a plurality of carrier zones, each carrier zone being sized to receive a frozen food item,
wherein the panel has (i) a folded configuration in which the panel is folded along a plurality of fold lines and has a first surface area, and (ii) an unfolded configuration in which the panel has a second surface area larger than the first surface area, and
wherein each carrier zone has (i) a first edge defined by a first fold line of the plurality of fold lines and (ii) a second edge defined by a second fold line of the plurality of fold lines, the second fold line extending orthogonal to the first fold line.

2. The sheet of claim 1, wherein:
when the panel is in the folded configuration, the first edge of a first carrier zone overlaps with a second edge of an adjacent carrier zone, and
when the panel is in the unfolded configuration, the first edge is spaced apart from the second edge.

3. The sheet of claim 1, wherein when the panel is in the folded configuration, the panel has a first length and a first width, and when the panel is in the unfolded configuration, the panel has (i) a second length that is greater than the first length and (ii) a second width that is greater than the first width.

4. The sheet of claim 1, wherein the panel includes:
a first pane including a first carrier zone,
a second pane including a second carrier zone, and
a bridge extending between the first pane and the second pane, the bridge (i) being positioned below the first pane and above the second pane when the panel is in the folded configuration, and (ii) cooperating with the first pane and the second pane to define a plane when the panel is in the unfolded configuration.

5. The sheet of claim 4, wherein the panel further includes:
a third pane including a third carrier zone, and
a second bridge extending between the first pane and the third pane, the second bridge (i) being positioned below the first pane and above the third pane when the panel is in the folded configuration, and (ii) cooperating with the first pane, the second pane, the third pane, and the bridge to define the plane when the panel is in the unfolded configuration.

6. The sheet of claim 5, wherein the bridge is a first bridge and the second bridge partially overlaps with the first bridge when the panel is in the folded configuration.

7. The sheet of claim 1, wherein the panel is formed from parchment paper.

8. The sheet of claim 1, further comprising a locking mechanism to maintain the folded configuration of the panel in the folded configuration.

9. The sheet in claim 8, wherein the locking mechanism includes an outer flange positioned along an outer perimeter of the panel, the outer flange including a plurality of locking flanges positioned below a bottom surface of the panel.

10. The sheet in claim 9, wherein the outer flange further includes a plurality of tabs extending outwardly from below the panel.

11. A method of food preparation, comprising:
obtaining a folded sheet having a plurality of frozen food items positioned thereon, each frozen food item being adjacent to at least one other frozen food item,
expanding the folded sheet along a first axis to increase a first dimension of the folded sheet, and
expanding the folded sheet along a second axis to increase a second dimension of the folded sheet, the second axis being orthogonal to the first axis,
wherein expanding the folded sheet along the first axis and the second axis creates an unfolded sheet on which the frozen food items are spaced apart.

12. The method of claim 11, further comprising:
positioning the folded sheet on a baking pan, the baking pan having a pan surface area,
wherein (i) the folded sheet has a surface area that is less than the pan surface area, and (ii) the unfolded sheet has a surface area that is approximately equal to the pan surface area.

13. The method of claim 11, further comprising placing the unfolded sheet into an oven, and baking the frozen food items in the oven.

14. The method of claim 11, wherein obtaining the folded sheet comprises removing a package including the folded sheet and the plurality of frozen food items from a container.

15. The method of claim 14, wherein the package includes:
a cover sheet;
the folded sheet positioned below the cover sheet; and
the plurality of frozen food items positioned between the cover sheet and the folded sheet.

16. The method of claim 15, further comprising removing the cover sheet from the plurality of frozen food items before expanding the folded sheet.

17. A method of delivering frozen food items, comprising:
depositing a plurality of frozen food items on a first sheet,
placing a second sheet over the plurality of frozen food items to create a package, the second sheet being folded along a plurality of first fold lines and a plurality of second fold lines extending orthogonal to the first fold lines,
inserting the package into a container,
rotating the container 180 degrees such that the second sheet is positioned below the plurality of frozen food items and the first sheet is positioned above the plurality of frozen food items, and
sealing the container.

18. The method of claim 17, further comprising:
removing the package from the container,
detaching the first sheet from the plurality of frozen food items,
unfolding the second sheet along the first fold lines to increase a first dimension of the second sheet, and
unfolding the second sheet along the second fold lines to increase a second dimension of the second sheet,
wherein unfolding the second sheet along the first fold lines and the second fold lines creates an unfolded sheet on which the frozen food items are spaced apart.

19. The method of claim 18, wherein unfolding the second sheet along the first fold lines includes pulling on a first tab in a first direction and a second tab in a second direction opposite the first direction.

20. The method of claim 17, further comprising:
depositing a plurality of frozen food items on a third sheet,
placing a fourth sheet over the plurality of frozen food items to create a second package, the fourth sheet being folded along a plurality of first fold lines and a plurality of second fold lines extending orthogonal to the first fold lines, and
inserting the second package into the container such that the third sheet is placed in contact with the first sheet.
